(19) United States
(12) Patent Application Publication
(10) Pub. No.: US 2020/0379230 A1
(43) Pub. Date: Dec. 3, 2020

(54) OPTICAL SETUP FOR MICROSCOPE AND MICROSCOPE

(71) Applicant: Leica Microsystems CMS GmbH, Wetzlar (DE)

(72) Inventor: Frank SIECKMANN, Eppingen (DE)

(21) Appl. No.: 16/884,069

(22) Filed: May 27, 2020

(30) Foreign Application Priority Data
May 29, 2019 (DE) 102019207873.7

(51) Int. Cl. G02B 21/06; G02B 21/26

(52) U.S. Cl. CPC G02B 21/06; G02B 21/26

(57) ABSTRACT

An optical setup for a microscope includes a first optical arrangement having a first optical axis and facing a sample volume from a first side of the sample volume, and a second optical arrangement having a second optical axis and facing the sample volume from a second side of the sample volume, the first side of the sample volume lying opposite the second side of the sample volume. The first optical axis and the second optical axis pass through the sample volume. The first optical axis and the second optical axis are disposed in nonparallel fashion with respect to one another in the sample volume.

### CROSS-REFERENCE TO PRIOR APPLICATION

Priority is claimed to German Patent Application No. DE 10 2019 207 873.7, filed on May 29, 2019, the entire disclosure of which is hereby incorporated by reference herein.

### FIELD

The invention relates to an optical setup for a microscope, in particular for a wide-field microscope, comprising a first optical arrangement having a first optical axis and facing a sample volume from a first side of said sample volume and a second optical arrangement having a second optical axis and facing the sample volume from a second side of said sample volume, the first side lying opposite the second side of the sample volume. Further, the invention relates to a microscope comprising an objective receptacle for microscope objectives through which a microscope beam path extends.

### BACKGROUND

The prior art has disclosed a wide range of microscopy processes. These include light sheet microscopy, wide-field microscopy and confocal microscopy. Each microscopy method has its own advantages. By way of example, confocal microscopy is advantageous for the generation of high resolution microscopy images but less suitable for orientation in a sample.

In light sheet microscopy—known from the prior art—use is generally made of an illumination module and a detection module. A correct arrangement or adjustment of the two modules in a very small space usually requires great adjustment effort, both in respect of the modules and in respect of the sample itself. On account of the setup, the adjustment can be further hampered by virtue of the compact arrangement of the modules not allowing a view into a detection space, i.e., into a sample volume.

Further, solutions from the prior art may present difficulties when automatically replacing a sample with another sample, for example by way of a robot, and subsequently scanning the new sample. Similarly, it may be difficult to sufficiently quickly capture processes which change quickly over time in a plurality of samples on a sample holder since the adjustment is time-consuming. The increased adjustment outlay, even in light sheet microscopes, may further be an obstacle to high image recording and scanning speeds, which are inherently intrinsic to the light sheet microscopy. In general, solutions from the prior art can usually only scan individual samples at a high quality whereas scanning a plurality of samples at a high speed and in automated fashion is generally difficult to impossible.

### SUMMARY

In an embodiment, the present invention provides an optical setup for a microscope. The optical setup includes a first optical arrangement having a first optical axis and facing a sample volume from a first side of the sample volume, and a second optical arrangement having a second optical axis and facing the sample volume from a second side of the sample volume, the first side of the sample volume lying opposite the second side of the sample volume. The first optical axis and the second optical axis pass through the sample volume. The first optical axis and the second optical axis are disposed in nonparallel fashion with respect to one another in the sample volume.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows a schematic illustration of the optical setup according to an embodiment of the invention;

FIG. 2 shows a schematic illustration of an adapter arrangement according to an embodiment of the invention;

FIG. 3 shows the arrangement of FIG. 1 with a sample carrier;

FIG. 4 shows a further embodiment of the optical setup according to the invention with a receptacle vessel;

FIG. 5 shows a further embodiment of the optical setup of FIG. 4;

FIG. 6 shows a further embodiment of the optical setup of FIG. 4;

FIG. 7 shows a further embodiment of the optical setup according to the invention;

FIG. 8 shows a further embodiment of the optical setup/microscope according to the invention;

FIG. 9 shows a further embodiment of the optical setup according to the invention with an actuator;

FIG. 10 shows further embodiments of the optical setup according to the invention and of the microscope according to the invention; and

FIG. 11 shows further embodiments of the optical setup according to the invention and of the microscope according to the invention.

### DETAILED DESCRIPTION

Embodiments of the present invention provide an optical setup and a microscope which improve the solutions from the prior art, for example by virtue of reducing measurement times, ensuring a simpler and more manageable setup, providing a precise and sufficiently large measurement range and being more cost-effective.

For the optical setup specified at the outset, an embodiment of the invention solves the aforementioned problem by virtue of the first and second optical axis passing through the sample volume and the first optical axis and the second optical axis being disposed in nonparallel fashion with respect to one another in the sample volume. By way of example, the spatial arrangement of the first and second optical arrangement with respect to one another facilitates a simple and visible access to the sample volume, allowing adjustment times to be shortened. Further, this arrangement also allows a sample change to be implemented more quickly than in the case of solutions from the prior art.

For the microscope specified at the outset, an embodiment of the invention solves the aforementioned problem by virtue of the microscope further comprising an optical setup according to an embodiment of the present invention, the first optical arrangement or the second optical arrangement being fastened to an objective receptacle.

The optical setup according to embodiments of the invention and the microscope according to embodiments of the invention can be further improved by including features of the specific embodiments described below. The technical features of the further embodiments can be combined with one another as desired or else be omitted.

In particular, an optical setup should be understood to mean an arrangement of optical elements or assemblies. In principle, the optical setup according to an embodiment of the invention can be used with scanning or non-scanning methods. The optical setup according to an embodiment of the invention can be embodied to be integrated in a wide-field microscope or a confocal microscope, for example. In particular, the optical setup according to an embodiment of the invention can be used to enhance a wide-field microscope in modular fashion so that the enhanced wide-field microscope has an increased functional scope, i.e., an increased number of modes of operation.

The relative position of the first and second optical arrangement on different sides of the sample volumes is advantageous, for example, in that this simplifies aligning the sample, which is generally located in the sample volume. Both the first and the second optical axis are disposed so as to pass through the sample volume. The first and the second optical axis may intersect.

In a further embodiment of the optical setup according to the invention, the first of the second optical arrangement is configured to generate a light sheet in the sample volume. Expressed differently, the first or second optical arrangement is configured as a light sheet arrangement. In general, this can be realized by two options. Firstly, use can be made of a cylindrical lens to generate a so-called static light sheet (other optical elements which allow different focusing along mutually perpendicular planes, for example sagittal plane and parallel plane, are also usable). Another option lies in the generation of a so-called virtual light sheet, which can be generated by repetitive movement of a focused beam along one direction.

Consequently, this embodiment allows a light sheet to be formed in the sample volume by the first optical arrangement, proceeding from the first side, or allows the light sheet to be generated in the sample volume by the second optical arrangement proceeding from the second side of the sample volume, which lies opposite the first side.

In this embodiment, in particular, it is advantageous if the first and the second optical axis include an angle of between 45° and 90°, preferably of between 60° and 90°, further preferably of between 75° and 90°, and particularly preferably of substantially 90° between one another, at least in the sample volume. It is not essential in this case for the two optical axes to intersect in the sample volume. By way of example, when generating the virtual light sheet, this may only be the case at one scanning position while the light sheet is being generated.

The optical setup can be further improved by virtue of the first optical axis and the second optical axis being oriented substantially perpendicular to one another in the sample volume. This embodiment is advantageous, in particular, when using the first or second optical arrangement for generating a light sheet such that a detection of the light emitted by an illuminated plane can be implemented perpendicular to this plane, i.e., without distortion.

In a further advantageous embodiment of the optical setup according to the invention, the latter comprises a sample holder which is substantially disposed between the first and the second optical arrangement and which defines a sample plane likewise located between the first optical arrangement and the second optical arrangement. The sample holder can be a microscope stage. Alternatively, the sample holder can also be a plate or a holding apparatus for the sample carrier, which is disposed between the optical arrangements.

The microscope stage and the sample carrier can form a unit, i.e., the microscope stage can comprise the sample carrier. Illumination and detection of scattered light and/or fluorescence light is consequently implemented from or in spatially separated regions, wherein the spatial separation can be defined by the microscope stage and the sample plane defined by the latter. The sample holder or the microscope stage can have apparatuses that facilitate the reception of a sample. The sample can either be disposed on one side of the microscope stage or else be disposed in the receptacle apparatus in the microscope stage.

The optical setup according to the invention can have a positioning apparatus for positioning and/or moving the sample holder, in particular the microscope stage, in one, two or three spatial directions.

A mechanism/drive for moving the sample holder need not necessarily be located between the optical arrangements. By way of example, a robotic arm which displaces a sample holder between the optical arrangements could be conceivable.

The first optical axis and/or the second optical axis can intersect a sample plane defined thus at an angle of substantially 45°, i.e., said axes can include this angle with a sample plane.

The sample holder or the microscope stage can be configured to be movable along one or two directions, preferably perpendicular to one another, which are located within the sample plane. This can allow the sample to be moved along one or two directions and, for example, be moved in lateral scanning fashion through the first and/or second optical axis. In particular, a sample can consequently be moved through the light sheet in scanning fashion in order to record an image stack which facilitates a three-dimensional representation of the sample. Further, the sample holder/microscope stage can be displaceable along a z-direction or height direction. The height direction is preferably oriented perpendicular to the sample plane. Consequently, the microscope stage can be configured to be moved out of the sample plane in one direction. This facilitates the optimal placement of the light sheet within the sample and the scanning of correspondingly extended samples, and is particularly important for stitching, which is described further below.

The optical setup according to an embodiment of the invention can further be improved by virtue of the optical axis of the first and/or second arrangement being deflected by at least one deflection element on a side of the respective optical arrangement facing away from the sample volume. Consequently, should the first optical axis be followed proceeding from the sample volume, said optical axis, proceeding from the sample volume, passes the first optical arrangement and, subsequently, a deflection element, which can be referred to as first deflection element. Accordingly, the second optical axis can extend, proceeding from the sample volume, through the second optical arrangement and subsequently through a deflection element, a second deflection element. The deflection element can deflect a first beam path entering the optical setup according to the invention through substantially 45°, in particular. Accordingly, a second beam path fed into the second side of the sample volume can be deflected by the second deflection element, likewise preferably through substantially 45°. Consequently, the optical setup according to the invention can advantageously be used to enhance existing microscopes since their first beam path, which is generally oriented perpendicular to the sample plane, can be deflected by a deflection element according to the invention. Here, the second optical arrangement can further be an additional illumination arrangement or a deflection device provided for deflecting or coupling light emitted by an illumination arrangement of the microscope.

The optical setup according to the invention can provide for at least one adapter arrangement with at least one interchangeable adapter unit in a further embodiment, the adapter arrangement being connectable to the first or the second optical arrangement and comprising the at least one deflection element. The interchangeable adapter unit can be equipped, for example, with a microscope connector known from the prior art (e.g., bayonet closure/screw closure/etc.).

In a further advantageous embodiment of the optical setup according to the invention, a connector apparatus can be provided at at least one light entry or light exit opening for the purposes of fastening the adapter arrangement to an objective receptacle of a microscope and/or a receptacle apparatus can be provided at at least one light entry or light exit opening for the purposes of receiving a connector of an optical arrangement. Consequently, the adapter arrangement can represent an intermediate piece which can be provided between an objective, i.e., more generally, an optical arrangement, and a microscope, which can be fastened to the microscope, in particular, and to which the optical arrangement can be fastened in turn.

A light beam introduced through a first light entry or light exit opening can be tilted through substantially 45° with respect to a light beam emerging from the second light entry or light exit opening.

If two deflection elements are used in one embodiment, i.e., respectively one deflection element for the first and for the second optical arrangement, it is advantageous if the two deflection elements are identical. This allows these to be interchanged as desired. In another embodiments, the adapter arrangement can deflect the introduced light beam through an angle that differs from 45°, i.e., for example, 30-40° or 50-60° or 15-40° or 50-75°, with respect to the emerging light beam. Accordingly, the adapter arrangements provided at the first optical arrangement and at the second optical arrangement can be combined in such a way that the first and the second axis continue to include an angle of substantially 90° with respect to one another, the two adapter arrangements however providing a different deflection of the respective axis.

The optical setup can be fastened, in particular by way of the adapter arrangement, to a turret, preferably a rotatable turret, of a microscope. Consequently, it is possible to easily alternate between the use of the optical setup according to the invention and further optical setups provided on the turret, for example further microscope objectives.

The setup according to an embodiment of the invention can be further improved by virtue of the first and/or the second optical arrangement comprising an actuator by means of which an optical path along the corresponding optical axis associated with the optical arrangement is variably adjustable. Focusing or autofocusing can be implemented by means of such an actuator. That is to say, this actuator is used to set the focus of the corresponding optical arrangement. Further, it is conceivable for the actuator to be embodied to scan a sample using the corresponding first or second beam path. The actuator may comprise a piezo element or may be manually actuatable.

In a further advantageous embodiment of the optical setup according to the invention, the optical setup can have at least one receptacle vessel for receiving an immersion medium, wherein the base of the receptacle vessel has a receptacle opening and wherein the receptacle opening is configured to receive a front end of the first optical arrangement or the second optical arrangement, said front end facing the sample volume.

The receptacle vessel can be used in a microscope, independently of the previously described embodiments of the optical setup. The use of a receptacle vessel is advantageous in that an immersion liquid receivable in the reception vessel ensures an optimal optical flow to and into the sample, in such a way that reflections at surfaces to the sample volume (e.g., of a sample or preparation carrier) can be reduced or entirely avoided. The receptacle vessel is preferably disposed together with the corresponding first optical arrangement or second optical arrangement on the first or respectively second side of the sample medium. Further, the receptacle vessel can be a tub, into which the first or second optical arrangement can protrude through the receptacle opening.

The receptacle vessel can be configured to receive water, glycerol, oil, gas or other suitable materials as an immersion medium.

The receptacle vessel can be improved by virtue of a refill or emptying apparatus being provided, the feed and discharge line of which is connected to the receptacle vessel, wherein the refill or emptying apparatus is configured to fill and/or refill the receptacle vessel with the immersion medium and/or to empty the receptacle vessel. Such a refill or emptying apparatus can be provided with the receptacle vessel or by the optical setup according to the invention and is advantageous in that it allows an immersion medium to be refilled, for example, if the latter evaporates in a heat chamber. In particular, the receptacle vessel can be filled in automated fashion. Further, a replacement of the immersion medium is possible in order to be able to select and interchange the latter in a targeted fashion such that optical adaptation to a medium present in the sample volume is facilitated.

The receptacle vessel may have a fill level sensor. This fill level sensor can transmit the fill level of the immersion medium in the receptacle vessel to an electronic control module so that the control module can control a pump via connection lines. To this end, the pump can be connected to a reservoir by a tube such that the immersion liquid can be pumped from said reservoir into the receptacle vessel. The pump can be configured to both fill the receptacle vessel and pump the latter empty since the receptacle vessel must be pumped empty if a different optical arrangement should be used with the receptacle vessel and the immersion medium should simultaneously be prevented from entering the system.

In particular, the receptacle vessel can be fastened to the optical arrangement whose front end pierces the base of the receptacle vessel. Consequently, moving the optical arrangement protruding into the receptacle vessel allows simultaneous movement of said receptacle vessel.

In a further advantageous embodiment of the optical setup according to the invention, the optical setup can have an at least partly optically transmissive sample carrier, a sample being positionable in the sample volume on the one side thereof and the receptacle vessel being positionable on the other side thereof, wherein the receptacle vessel is Tillable with an immersion medium and wherein the receptacle vessel is positionable at a distance from the sample carrier by virtue of the immersion medium forming a meniscus bridging said distance.

Consequently, a small distance can be set between the receptacle vessel and the microscope stage or a sample carrier by means of the adhesion of the immersion medium, without an air gap arising between the sample carrier and the immersion medium. This distance between receptacle vessel and sample carrier can be more than 100 μm and up to 500 μm and allows the sample carrier to be displaced along a direction lying in the sample plane without interrupting the optical adaptation by the immersion medium. A meniscus forming between the immersion medium and the sample carrier consequently glides along the sample carrier in the case of such a movement.

Consequently, the immersion medium can attach itself to the surface of a sample carrier or preparation carrier by way of an adhesive force. The adhesive force can ensure that the optical flow through the immersion medium is not interrupted when the preparation carrier, and hence the sample, is moved away from the receptacle vessel. The immersion medium is configured (in respect of its refractive index) in such a way that there preferably is no reflection at the surface of the preparation carrier. The sample carrier can consist of a suitable optically transparent material such as, e.g., glass or specific glass specified for certain wavelength ranges. The immersion medium can completely surround a front end of an optical arrangement (the first or the second optical arrangement) received therein.

The sample to be examined can be located in an optical medium which corresponds to the immersion medium. Further, a base of the preparation carrier can have a similar refractive index to the immersion medium. Should the refractive indices of the immersion medium and of the base of the preparation carrier differ, there is only a beam offset; the angle alignment of the first or second optical axis in the sample volume remains unchanged, and so the first and second optical axis can be oriented substantially perpendicular to one another. The parallel offset can easily be compensated mechanically by virtue of moving the first optical arrangement or the second optical arrangement (preferably on the respective optical axis).

The optical setup according to the invention can be improved by virtue of the first optical arrangement and/or the second optical arrangement comprising an objective.

The microscope according to the invention mentioned at the outset can comprise any of the above-described embodiments of the optical setup according to the invention. The first optical arrangement or the second optical arrangement can be fastened indirectly, i.e., by way of the adapter arrangement, or directly to the objective receptacle.

The microscope according to an embodiment of the invention is advantageous in that various light-microscopic methods, such as light sheet microscopy, wide field microscopy and different processes of confocal microscopy can be unified in a single microscope. Consequently, if a turret is used, different optical arrangements can be selected in the microscope according to the invention, said optical arrangements being configured to facilitate or carry out one of the above-mentioned microscopy methods. The microscope according to the invention can be configured to automatically switch between the methods. In particular, the optical setup according to the invention can consequently cost-effectively retrofit an already available microscope, for example a wide-field microscope.

The microscope according to an embodiment of the invention can have various displacement apparatuses which are configured to displace the first optical arrangement in relation to the second optical arrangement, preferably independently of one another, along each of the three possible spatial directions. Should an objective turret be provided, there could be an automatic re-localization, i.e., an automatic positioning of the first optical arrangement with respect to the second optical arrangement, when the objective introduced into the beam path of the microscope is changed, i.e., depending on the employed optical arrangement.

The first and the second optical arrangement can preferably be movable independently of one another, with the first optical axis and the second optical axis preferably being perpendicular to one another and one of the two optical arrangements being configured to generate a light sheet in the sample volume.

The optical apparatus according to an embodiment of the invention and the microscope according to an embodiment of the invention are advantageous in that only an optical arrangement may be situated in the vicinity of the sample, whereas the other optical arrangement is located on the side opposite to the sample. This is advantageous in that a preparation carrier carrying the sample can be moved substantially freely in all three spatial directions, and so other or new samples can be continuously introduced into the sample volume. Consequently, a virtually arbitrarily large area can be provided according to the invention for the purposes of housing samples. Automated and quick processing of a multiplicity of samples is consequently possible (high throughput applications). Likewise, the sample volume can be filled with an immersion medium or can be surrounded by the latter. By way of example, the first optical arrangement can be immersed therein. The preparation carrier with a sample space and a sample base can be located between the two optical arrangements. The first and second optical arrangement can be disposed opposite one another in congruent fashion. The adapter arrangement can be connected to the objective turret by means of a connector apparatus, for example a thread. Preferably, this connection can be reversible such that the optical arrangement can be replaced by another optical arrangement.

The first and/or second optical arrangement can be moved relative to one another, firstly by way of the above-described actuator, with such an actuator facilitating a play-free travel along the corresponding respective optical axis. By way of example, the actuator can be a piezo element which can be controlled by way of an electronic component that can further facilitate automatic focusing. Further, manually operable focusing elements are also conceivable.

So that optical arrangements with a short working distance can also be used in the microscope according to the invention, an object turret carrying the corresponding optical arrangement can be displaced in such a way that the optical arrangement can be pushed closer to a generated light sheet. The first optical arrangement and the second optical arrangement can be displaced independently of one another along two substantially perpendicular directions, preferably within the sample plane. By way of example, this can be realized by a motor. Further, the microscope can have a rail, to which the objective turret, or the first optical arrangement or the second optical arrangement, can be fastened. By way of example, this allows the entire system to be moved back and forth in reversible and reproducible fashion by means of a motor drive. Such a movement can compensate the above-described parallel offset resulting from the base of the preparation carrier. An image stack for generating a three-dimensional representation of the sample to be examined by way of a respective movement of the sample volume or of the first and second optical arrangement along one of the three spatial directions can be recorded using the microscope according to an embodiment of the invention.

In particular, the microscope according to an embodiment of the invention can be configured to provide or allow an orientation in the sample volume or in the sample disposed in the sample volume (this orientation can also be referred to as a pre-scan) and to subsequently measure a selected region of the sample at a higher resolution on the basis of the advance scan or the advance recording.

In one configuration, the system according to an embodiment of the invention can consequently be used for automatic or manual detection of samples. In the process, the detected samples can initially be automatically or manually determined or detected by an image analysis by means of an image recorded quickly and over a large area, for example a wide-field recording. Following this, the first and second optical arrangement can be replaced in manual or automatic fashion, preferably for an optical arrangement that is configured to generate a light sheet in the sample volume. Following this, there can be a high resolution measurement of the region of interest in the sample.

The microscope according to an embodiment of the invention allows so-called “mosaicking” i.e., recording and subsequently putting together (“stitching”) of partial scans of samples in order to obtain an optimal illumination by means of the light sheet. To this end, the xz-position of the sample carrier is altered in order to displace the light sheet in a plane of the sample.

A microscope having a first and/or second optical arrangement configured to generate a light sheet corresponds to a light sheet microscope.

The microscope according to an embodiment of the invention can advantageously be used to carry out the following method.

A prescan (overview scan, scan for generating an overview image) is performed by means of a detection objective with a deactivated light sheet (microscopy methods to this end are, e.g., wide-field microscopic or scanning methods; typically, a method that is as simple/quick as possible is chosen). Following this prescan, the light sheet is activated in order now to use the latter for illumination purposes, and the objective turret of the first optical arrangement is rotated for the purposes of using an adapter plus objective for detection purposes. In the process, it is possible to apply further settings in respect of the positioning of the sample carrier relative to the optical arrangements, for example in order to observe a desired sample position and also to compensate an offset between an optical arrangement without and with an adapter arrangement. This facilitates the targeted observation of certain samples/sample regions by means of light sheet microscopy, particularly in the case of high throughput methods.

However, it would also be conceivable to use a light sheet microscopic method for a prescan by means of an embodiment of the microscope according to the invention and to then switch to a scanning, possibly high-resolution method, for example, in order to make a detailed recording of a specific sample region.

One embodiment has a perpendicular alignment of the first optical axis of the first optical arrangement in relation to the plane of the sample carrier and an oblique second optical axis of the second optical arrangement, wherein the first optical arrangement serves for detection purposes and the second optical arrangement serves for illumination purposes by means of a light sheet. Further, the illumination by means of a light sheet can also be implemented by means of the first optical arrangement with a perpendicular alignment.

Although some aspects have been described in the context of an apparatus, it is clear that these aspects also constitute a description of the corresponding method, wherein a block or an apparatus corresponds to a method step or a function of a method step. Analogously thereto, aspects described in the context of a method step also constitute a description of a corresponding block or element or a property of a corresponding apparatus. Some or all of the method steps can be carried out by (or using) a hardware apparatus, such as, for example, a processor, a microprocessor, a programmable computer or an electronic circuit. In some exemplary embodiments, one or more of the most important method steps can be carried out by such an apparatus.

Depending on specific implementation requirements, exemplary embodiments of the invention can be implemented in hardware or software. The implementation can be carried out with a non-volatile storage medium such as a digital storage medium, such as, for example, a floppy disk, a DVD, a Blu-Ray, a CD, a ROM, a PROM and an EPROM, an EEPROM or a FLASH memory, on which are stored electronically readable control signals which cooperate (or can cooperate) with a programmable computer system such that the respective method is carried out. Therefore, the digital storage medium can be computer-readable.

Some exemplary embodiments according to the invention comprise a data carrier with electronically readable control signals which can cooperate with a programmable computer system, such that one of the methods described herein is carried out.

In general, exemplary embodiments of the present invention can be implemented as a computer program product having a program code, wherein the program code is effective for carrying out one of the methods when the computer program product is executed on a computer. The program code can be stored on a machine-readable carrier, for example.

Further exemplary embodiments comprise the computer program for carrying out one of the methods described herein, said computer program being stored on a machine-readable carrier.

In other words, one exemplary embodiment of the present invention is therefore a computer program having a program code for carrying out one of the methods described herein when the computer program is executed on a computer.

A further exemplary embodiment of the present invention is therefore a storage medium (or a data carrier or a computer-readable medium) comprising a computer program stored thereon for carrying out one of the methods described herein when it is executed by a processor. The data carrier, the digital storage medium or the recorded medium is generally tangible and/or not seamless. A further exemplary embodiment of the present invention is an apparatus, as described herein, which comprises a processor and the storage medium.

A further exemplary embodiment of the invention is therefore a data stream or a signal sequence constituting the computer program for carrying out one of the methods described herein. The data stream or the signal sequence can be configured for example so as to be transmitted via a data communication connection, for example via the internet.

A further exemplary embodiment comprises a processing means, for example a computer or a programmable logic apparatus, which is configured or adapted to carry out one of the methods described herein.

A further exemplary embodiment comprises a computer on which the computer program for carrying out one of the methods described herein is installed.

A further exemplary embodiment according to the invention comprises an apparatus or a system configured to transmit (for example electronically or optically) a computer program for carrying out one of the methods described herein to a receiver. The receiver can be for example a computer, a mobile apparatus, a storage apparatus or the like. The apparatus or the system can comprise for example a file server for transmitting the computer program to the receiver.

In some exemplary embodiments, a programmable logic apparatus (e.g. a field programmable gate array, FPGA) can be used to implement some or all of the functionalities of the methods described herein. In some exemplary embodiments, a field programmable gate array can cooperate with a microprocessor in order to carry out one of the methods described herein. In general, the methods are preferably carried out by any hardware device.

Below, the invention should be described on the basis of embodiments described in more detail in drawings. The shown embodiments each represent a specific embodiment, the technical features of which can be combined with one another or omitted as desired, wherein none of the shown embodiments should be construed as restricting the sought-after scope of protection.

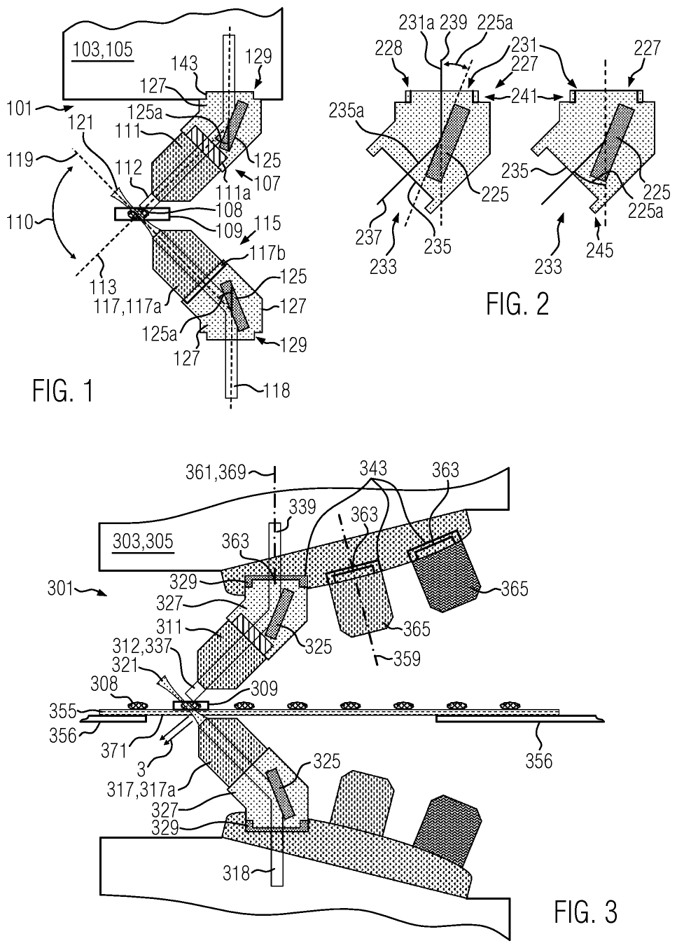

FIG. 1 schematically illustrates the optical setup 101 according to an embodiment of the invention. The latter can be used in a microscope 103, in particular in a wide-field microscope 105. The latter is indicated schematically. A first side 107 and a second side 115 are defined proceeding from a sample volume 109. A first optical arrangement 111, which comprises a first optical axis 113, faces the sample volume 109. Analogously, a second optical arrangement 117 faces the sample volume 109 from the second side 115 of the sample volume 109. The second optical arrangement 117 comprises a second optical axis 119. The first side 107 lies opposite the second side 115. Both the first 113 and the second optical axis 119 pass through the sample volume 109 and are not parallel to one another.

In the shown embodiment of the optical setup 101, the second optical arrangement 117 is configured to generate a light sheet 121 in the sample volume 109. Consequently, the second optical arrangement 117 represents a light sheet arrangement 117a.

In the sample volume 109, the first optical axis 113 and the second optical axis 119 are oriented at an angle 110 with respect to one another, said angle being 90° in the shown embodiment. Consequently, the optical axes 113, 119 are oriented perpendicular to one another.

The optical setup 101 further comprises two adapter arrangements 127, which each comprise a changeable adapter unit 129.

The adapter arrangements 127 are connected to the first 111 and the second optical arrangement 117 and each comprise a deflection element 125.

In the case of the first optical arrangement 111, the deflection element 125 deflects the light 112 emanating from a sample 108 through a deflection angle 125a. Accordingly, the deflection element 125 provided in the adapter arrangement 127 connected to the second optical arrangement 117 likewise deflects the light 118 radiated thereon through the deflection angle 125a and toward the sample volume 109.

Moreover, FIGS. 3 to 11 show further embodiments of the optical setup 101 according to the invention and of the microscope 103. The description of the technical features of the embodiment of the optical setup 101 or of the microscope 103 shown in FIG. 1 is also transferable to embodiments of FIGS. 3 to 11, with the hundreds place of the employed reference sign denoting the figure and the tens and the unit place denoting the referenced technical feature. Differences between the embodiments shown in the figures are explicitly referred to, whereas a repeated description of technical features already described previously is dispensed with.

FIG. 2 shows an adapter arrangement 227 according to the invention. The latter exhibits a first light entry or light exit opening 231 at a first end 28 and a second light entry or light exit opening 235 at a second end 233. A light beam 237, which is introduced into the adapter arrangement 227 at the first 231 or the second light entry or light exit opening 235 is tilted through 45° in the shown embodiment with respect to the light beam 239 emanating from the respective other light entry or light exit opening, i.e., the second 235 or the first light entry or exit opening 231. This is achieved by a mirror angle 225a, with which the deflection element 225 is oriented with respect to the perpendicular 231a, 235a of the first 231 or second light entry or light exit opening 235.

In the shown embodiment, the adapter arrangement 227 has a connector apparatus 241 for fastening the adapter arrangement 237 to an objective receptacle 143 of a microscope 103, 105 (see FIG. 1). Further, provision is made of a receptacle apparatus 245 for receiving a connector 111a, 117a of an optical arrangement 111, 117 (see FIG. 1).

Even if the embodiment of the adapter arrangement 227 according to the invention shown in FIG. 2 has a deflection angle 225a of 45°, the present invention is not restricted to such a deflection angle 225a. Furthermore, deflection angles 225a of greater than or less than 45° are conceivable.

Particularly preferably, the deflection angles 225a of the adapter arrangements 127, 227 disposed on the first side 107 and on the second side 115 are symmetrical or complement one another in such a way that the respective optical axes 113, 119 are aligned substantially perpendicular to one another within the sample volume 109 (see FIG. 1).

FIG. 3 shows a further embodiment of the optical setup 301 according to the invention or of the microscope 303 according to the invention. An at least partly optically transmissive sample carrier 355 is disposed between the first optical arrangement 311 and the second optical arrangement 317. Said sample carrier rests on a schematically indicated microscope stage 356.

The embodiment of the microscope 303 according to the invention shown in FIG. 3 further has an objective turret 357, the turret axis of rotation 359 of which is disposed offset from a microscope axis 361. Moreover, in the embodiment shown in FIG. 3, the turret axis of rotation 359 is inclined with respect to the microscope axis 361.

Further, three objective receptacles 343 are shown in the example shown, the respective centers 363 of which having the same distance from the turret axis of rotation 359. Consequently, rotating the objective turret 357 allows introduction or use of the first optical arrangement 311 (with the corresponding adapter arrangement 327) or of further optical arrangements 365, for example objective 367, in the microscope beam path 369 indicated by the microscope axis 361.

As shown in FIG. 3, it is possible on the sample carrier 355 for a component of the incoming light 318, which is focused toward the sample volume 309 by the light sheet arrangement 317a, to be reflected at a surface 371 of the sample carrier 355 and to lead to a reflected light component 373. This reflected light component 373 is no longer available for microscopy and reduces the efficiency of the illumination of the sample 308 with the incoming measurement light 318.

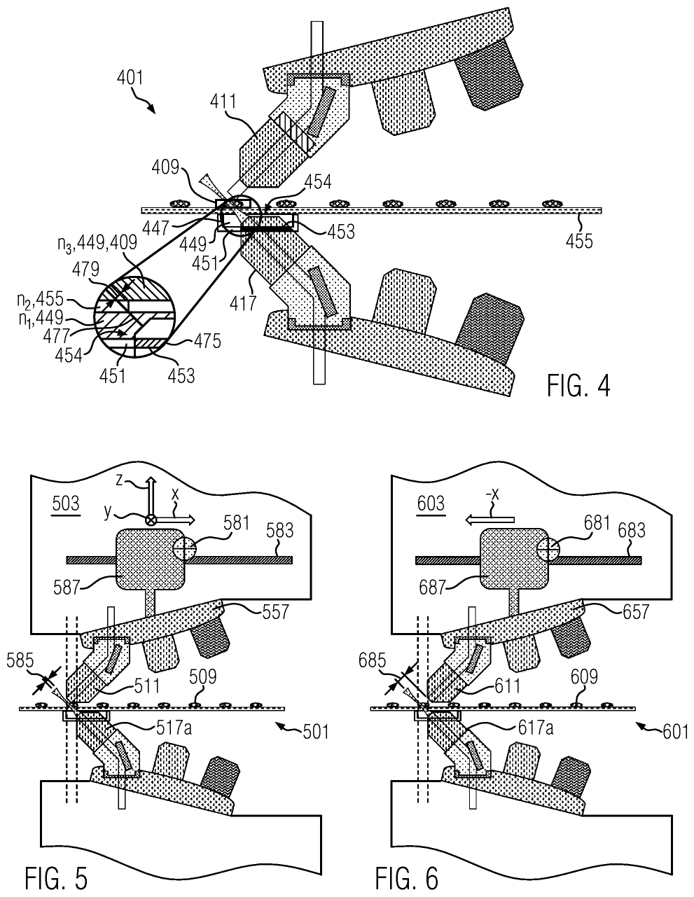

The embodiment of the optical setup 401 according to the invention shown in FIG. 4 can prevent the reflected light component 373 from occurring.

The optical setup 401 in FIG. 4 comprises a receptacle vessel 447, in which an immersion medium 449 is received. A base 451 of the receptacle vessel 447 has a receptacle opening 453. A front end 454 of the second optical arrangement 417, which faces the sample volume 409, is received in this receptacle opening 453. It could be the front end 454 of the first optical arrangement 411 that is received in other embodiments of the optical setup according to the invention.

The effect of the receptacle vessel 447 and of the immersion medium 449 is schematically illustrated in a magnification 475, with only a central ray 477 being presented for illustrative purposes. In the ideal case, this central ray 477 is not refracted at the sample carrier 455. This is the case if a refractive index n₁ of the immersion medium 449 corresponds to the refractive index n₂ of the sample carrier 455. Further, an immersion medium 449 can likewise be provided in the sample volume 409, said immersion medium particularly preferably having a refractive index n₃, which corresponds to the refractive index n₂ and the refractive index n₁. Such a course of the central ray 477 is represented by a dashed line in the magnification 475. However, matching the refractive indices n₁ and n₃ to the refractive index n₂ is not mandatory, with the central ray 477 merely experiencing a transverse offset 479 for the case n₂>n₁ and n₂>n₃. For illustrative purposes, this is presented in exaggerated fashion by a dotted line. Consequently, there is no change in the angle at which the central ray 477 consequently enters into the sample volume 409.

Such a transverse offset 479 can easily be compensated by virtue of the first optical arrangement 411 being displaced. This is shown in FIGS. 5 and 6. Shown here is an embodiment of the microscope 503, 603 according to the invention, which has a motor drive 581, 681 which allows the objective turret 557, 657 to be moved along (FIG. 5) or counter to an x-direction (FIG. 6) along a rail 583, 683.

Such a movement also renders it possible to use a first optical arrangement 511, which has a shorter working distance 585 (in comparison with the working distance 685) than the first optical arrangement 611.

Further, the microscope 503, 603 according to the invention can have additional apparatuses (not shown) which allow the objective turret 557, 657, and hence the first optical arrangement 511, 611, to be displaced along the y-direction or along the z-direction. If a light sheet arrangement 517a, 617a is used in the microscope 503, 603 according to the invention, recording an image stack is rendered possible by means of each displacement along the three spatial directions x, y, z. Here, the direction of the displacement can orient itself along the extent of the sample 509, 609. Thus, in the shown samples 509, 609 of FIG. 5 and FIG. 6, a movement along or counter to the x-axis would be advantageous. A translation module 587, 687 can also comprise these apparatuses for displacing the objective turrets 557, 657 as corresponding control apparatuses (not shown).

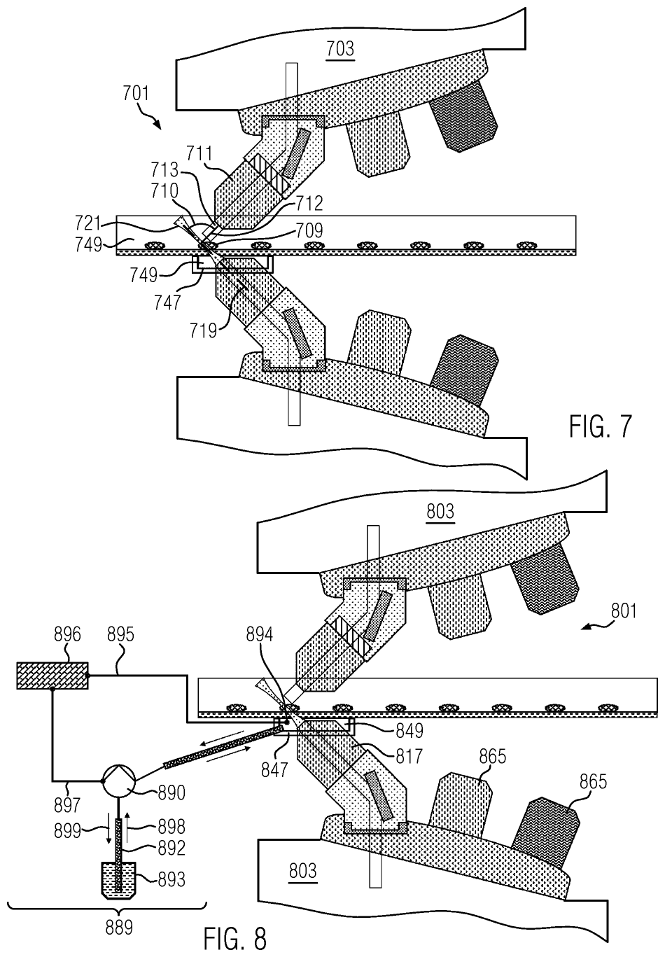

FIG. 7 presents a further embodiment of the microscope 703 according to the invention or of the optical setup 701 according to the invention. In this embodiment, the first optical arrangement 711 is immersed in an immersion medium 749 which, in particular, corresponds to the immersion medium 749 received in the receptacle vessel 747. This ensures that the light 712 emitted by the sample 709 is not refracted at an interface (not shown) between the sample 709 and air (not shown) and consequently that there is no change in an angle 710 between the two optical axes 713 and 719. Consequently, this ensures that (in light sheet microscopy in particular) the region of the sample 709 illuminated by the light sheet 721 can be recorded without projection and in undistorted fashion.

FIG. 8 shows a further embodiment of the microscope 803 according to the invention or of the optical setup 801 according to the invention. This embodiment is similar to that in FIG. 7, with provision further being made of a refill or emptying apparatus 889.

The refill or emptying apparatus 889 comprises a pump 890, a feed line 891, a tube 892 connected to a reservoir 893, and a fill level sensor 894 which is connected to a control module 896 via a sensor line 895 such that the pump 890 can be controlled via a control line 897 on the basis of the fill level in the receptacle vessel 847 measured by the fill level sensor 894.

The refill or emptying apparatus 889 allows the receptacle vessel 847 to be filled with the immersion medium 849 (positive flow direction 898) or the receptacle vessel 849 to be emptied (negative flow direction 899). By way of example, this is advantageous if the microscope 303 is used in a heat chamber such that the immersion medium 849 received in the receptacle vessel 847 evaporates and can be topped up by the refill or emptying apparatus 889. The refill or emptying apparatus 889 can also be used when changing the immersion medium 849 or the employed second optical arrangement 817 or the employed further optical arrangement 865 in order to prevent an outflow of the immersion medium 849 into the microscope 803.

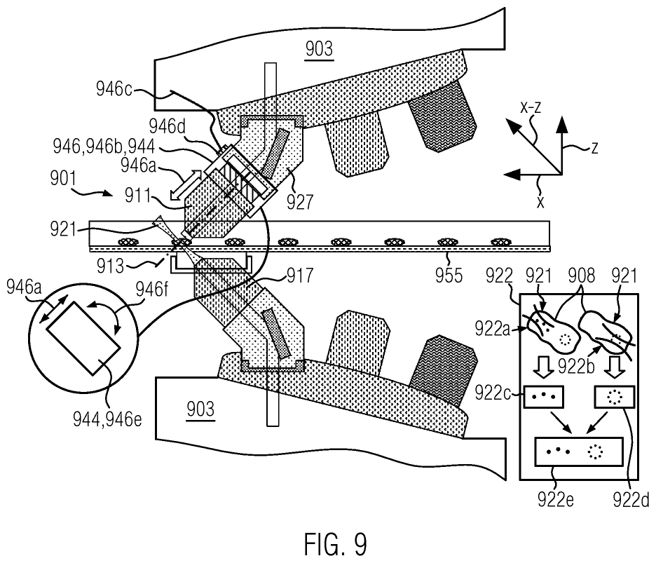

FIG. 9 shows a further embodiment of the microscope 903 according to the invention or of the optical setup 901 according to the invention. In this embodiment, the first optical arrangement 911 is indirectly connected to the corresponding adapter arrangement 927 by way of a focusing element 944. In the shown embodiment, the focusing element 944 is an actuator 946 which causes the first optical arrangement 911 to be received in displaceable fashion and without play along the first optical axis 913, i.e., causes the first optical arrangement 911 to be able to be displaced along an actuator direction 946a. By way of example, the shown actuator 946 can be a piezo actuator 946b, by means of which the first optical arrangement 911 can be moved by a piezo element (not shown) by means of an appropriate control line 946c. To this end, a control signal provided by means of the control line 946c can be preprocessed by a suitable electronic component 946b.

In FIG. 9, only the first optical arrangement 911 is provided with an actuator 946. However, in an embodiment not shown, the second optical arrangement 917 can also have such an actuator 946. Further, it is possible for the focusing element 944 to be a mechanical actuator 946e, which facilitates a movement of the first optical arrangement 911 along the actuator direction 946a by way of a rotational movement 946f.

Other conceivable implementations for an actuator 946 could include an electromagnetic or pneumatic drive, for example.

The sample carrier 955 can also move in the embodiment of the microscope 903 according to the invention shown in FIG. 9. In particular, this movement can be implemented by the combined movement along the x-direction and the z-direction, leading to a combined xz-direction. Such an xz-direction is advantageous in that the latter can be directed along the light sheet 921 so that so-called mosaicking can be performed by means of the microscope 903 according to the invention. This is schematically described in a diagram 922. Here, the sample 908 is illuminated by the light sheet 921 in two regions 922a and 922b following the displacement along the xz-direction; this leads to a first 922c and a second image 922d, which yield an overall image 922e by so-called stitching, i.e., assembling. Likewise, an additional displacement in the y-direction is conceivable in order to scan correspondingly extended samples.

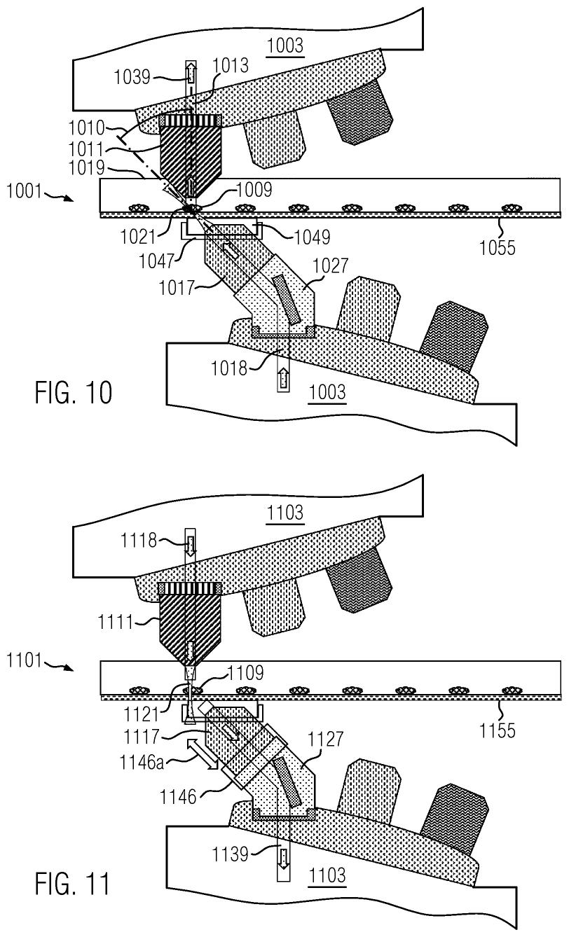

FIGS. 10 and 11 show two further embodiments of the microscope 1003, 1103 according to the invention or of the optical setup 1001, 1101 according to the invention. These differ from the previously shown embodiments in that the first optical arrangement 1011, 1111 is aligned perpendicular to the sample carrier 1055, 1155. In FIG. 10, incoming light 1018 is coupled by the adapter arrangement 1027 into the second optical arrangement 1017 and focused by way of the receptacle vessel 1047 and a corresponding immersion medium 1049 in such a way that an oblique light sheet 1021 is formed in the sample 1009. The emerging light beam 1039 of the detected measurement light is collected by the first optical arrangement 1011 and transmitted for processing purposes. The angle 1010 between the first optical axis 1013 and the second optical axis 1019 is 45°. This leads to the region of the sample 1009 illuminated by the light sheet 1021 being observed under an inclination angle, and so a subsequent image erection (not shown) is required. This can be implemented by way of a software and/or hardware solution.

Accordingly, the light sheet can also be generated by the first optical arrangement 1111, like in FIG. 11. Here, the incoming light 1118 is radiated into the sample 1109 through the first optical arrangement 1111 such that the arising light sheet 1121 is perpendicular to the sample carrier 1155. The detection is implemented by means of the second optical arrangement 1117, which moreover has an actuator 1146 that is displaceable along the actuator direction 1146a. The emerging light beam 1139 is collected by the second optical arrangement 1117 and transmitted by way of a corresponding adapter arrangement 1127 for detection purposes.

The individual technical features of the embodiments of the microscope 103, 203, . . . , 1003, 1103 according to the invention or of the optical setup 101, 201, . . . , 1001, 1101 according to the invention, which have been described and shown in the aforementioned figures, can be combined with one another as desired. Consequently, according to the invention, provision can be made for technical features shown in FIG. 9 also to be provided in embodiments of FIG. 1, FIG. 3, FIG. 4, etc. In particular, mentioning a technical feature, for example the actuator 946 in FIG. 9, does not prevent the embodiment of FIG. 5, for example, from being able to be complemented by such an actuator, even if the reference sign 946 indicates that the actuator is introduced in FIG. 9 and even if the embodiment of FIG. 5 itself does not exhibit an actuator.

For reasons of clarity, the list of reference signs consequently does not individually list each embodiment of individual technical features. For example, the optical setup is only listed with reference sign 101, with the reference signs 301, 401, . . . , 1001, 1101 likewise denoting the optical setup.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

101 Optical setup
103 Microscope
105 Wide-field microscope
107 First side
109 Sample volume
110 Angle
111 First optical arrangement
111a Connector
112 Emitted light
113 First optical axis
115 Second side
117 Second optical arrangement
117a Light sheet arrangement
117b Connector
119 Second optical axis
121 Light sheet
125 Deflection element
125a Deflection angle
127 Adapter arrangement
129 Adapter unit
143 Objective receptacle
225a Mirror angle
228 First end
231 First light entry or light exit opening
231a Perpendicular
233 Second end
235 Second light entry or light exit opening
235a Perpendicular
237 Introduced light beam
239 Emerging light beam
241 Connector apparatus
245 Receptacle apparatus
355 Partly optically transmissive sample carrier
356 Microscope stage
357 Objective turret
359 Turret axis
361 Microscope axis
363 Center
365 Further optical arrangement
367 Objective
369 Microscope beam path
371 Surface
373 Reflected light component
447 Receptacle vessel
449 Immersion medium
451 Base
453 Receptacle opening
475 Magnification
477 Central ray
479 Lateral offset
581 Motor drive
583 Rail
585 Transverse offset
587 Translation module
681 Motor drive
683 Rail
685 Transverse offset
687 Translation module
889 Refill or emptying apparatus
890 Pump
891 Feed line
892 Tube
893 Reservoir
894 Fill level sensor
895 Sensor line
896 Control module
897 Control line
898 Positive flow direction
899 Negative flow direction
922 Diagram
922a Region
922b Region
922c First image
922d Second image
944 Focusing element
946 Actuator
946a Actuator direction
946b Piezo actuator
946c Control line
946d Electronic component
946e Mechanical actuator
946f Rotational movement

What is claimed is:

1. An optical setup for a microscope, the optical setup comprising:
a first optical arrangement having a first optical axis and facing a sample volume from a first side of the sample volume; and
a second optical arrangement having a second optical axis and facing the sample volume from a second side of the sample volume, the first side of the sample volume lying opposite the second side of the sample volume,
wherein the first optical axis and the second optical axis pass through the sample volume, and
wherein the first optical axis and the second optical axis are disposed in nonparallel fashion with respect to one another in the sample volume.

2. The optical setup as claimed in claim 1, wherein the first optical arrangement or the second optical arrangement is configured to generate a light sheet in the sample volume.

3. The optical setup as claimed in claim 1, wherein the first optical axis and the second optical axis are oriented substantially perpendicular to one another in the sample volume.

4. The optical setup as claimed in claim 1, further comprising a microscope stage which is substantially disposed between the first and the second optical arrangement and which defines a sample plane likewise located between the first optical arrangement and the second optical arrangement.

5. The optical setup as claimed in claim 4, further comprising a positioning apparatus configured to position and/or move the microscope stage in one, two or three spatial directions.

6. The optical setup as claimed in claim 4, wherein the first optical axis and/or the second optical axis includes an angle of substantially 45° with the sample plane.

7. The optical setup as claimed in claim 1, wherein the first optical axis and/or the second optical axis is deflected by at least one deflection element on a side of the respective optical arrangement facing away from the sample volume.

8. The optical setup as claimed in claim 7, further comprising at least one adapter arrangement with at least one interchangeable adapter unit, the at least one adapter arrangement being connectable to the first optical arrangement or the second optical arrangement and comprising the at least one deflection element.

9. The optical setup as claimed in claim 8, wherein the at least one adapter arrangement has a first light entry or light exit opening at a first end and a second light entry or light exit opening at a second end, whereby a light beam introduced through the first light entry or light exit opening is tilted through substantially 45° with respect to the light beam emerging from the second light entry or light exit opening.

10. The optical setup as claimed in claim 9, further comprising
a connector apparatus disposed at at least one of the light entry or light exit openings and configured to fasten the at least one adapter arrangement to an objective receptacle of the microscope, and/or
a receptacle apparatus disposed at at least one of the light entry or light exit openings and configured to receive a connector of at least one of the optical arrangements.

11. The optical setup as claimed in claim 1, wherein the first optical arrangement and/or the second optical arrangement comprises an actuator, by which an optical path along the corresponding optical axis associated with the optical arrangement is variably adjustable.

12. The optical setup as claimed in claim 1, further comprising at least one receptacle vessel configured to receive an immersion medium, a base of the at least one receptacle vessel having a receptacle opening configured to receive a front end of the first optical arrangement or the second optical arrangement, the front end facing the sample volume.

13. The optical setup as claimed in claim 12, wherein the at least one receptacle vessel is fastened to the optical arrangement whose front end pierces the base.

14. The optical setup as claimed in claim 12, further comprising a refill or emptying apparatus having a feed and discharge line which is connected to the at least one receptacle vessel, the refill or emptying apparatus being configured to fill and/or refill the at least one receptacle vessel with the immersion medium and/or to empty the at least one receptacle vessel.

15. The optical setup as claimed in claim 13, further comprising an at least partly optically transmissive sample carrier, a sample being positionable in the sample volume on one side of the sample carrier and the at least one receptacle vessel being positionable on the other side of the sample carrier, wherein the at least one receptacle vessel is fillable with the immersion medium and wherein the at least one receptacle vessel is positionable at a distance from the sample carrier by virtue of the immersion medium forming a meniscus bridging the distance.

16. The optical setup as claimed in claim 1, wherein the first optical arrangement and/or the second optical arrangement comprises an objective.

17. A microscope, comprising:
an objective receptacle for microscope objectives through which a microscope beam path extends; and
the optical setup as claimed in claim 1,
wherein the first optical arrangement or the second optical arrangement is fastened directly or indirectly to the objective receptacle.

18. The microscope as claimed in claim 17, wherein the microscope is a light sheet microscope.
